(19) United States
(12) Patent Application Publication
(10) Pub. No.: US 2023/0409344 A1
(43) Pub. Date: Dec. 21, 2023

(54) COMPUTER-READABLE RECORDING MEDIUM STORING EXECUTION CONTROL PROGRAM, EXECUTION CONTROL METHOD, AND INFORMATION PROCESSING DEVICE

(71) Applicant: Fujitsu Limited, Kawasaki-shi (JP)

(72) Inventor: Yusuke HAMADA, Ota (JP)

(73) Assignee: Fujitsu Limited, Kawasaki-shi (JP)

(21) Appl. No.: 18/305,759

(22) Filed: Apr. 24, 2023

(30) Foreign Application Priority Data
Jun. 16, 2022 (JP) 2022-097605

(51) Int. Cl. G06F 9/445

(52) U.S. Cl. CPC G06F 9/445

(57) ABSTRACT

A non-transitory computer-readable recording medium stores an execution control program for causing a computer to execute a process including: storing, for each of a plurality of commands common to a plurality of user interfaces, a function definition that defines processing to be executed in response to each of the plurality of commands with a combination of one or more classes among classes of a plurality of types; receiving an input of a specific command among the plurality of commands; and processing the specific command with the combination of the one or more classes defined by the function definition that corresponds to the received specific command.

### CROSS-REFERENCE TO RELATED APPLICATION

This application is based upon and claims the benefit of priority of the prior Japanese Patent Application No. 2022-97605, filed on Jun. 16, 2022, the entire contents of which are incorporated herein by reference.

### FIELD

The embodiment discussed herein is related to an execution control program, an execution control method, and an information processing device.

### BACKGROUND

When a machine learning model to be used in machine learning is developed or provided, the following user interfaces are commonly used. For example, a Command Line Interface (CLI), a function call, a Representation State Transfer (REST), an Application Programming Interface (API), a Web Graphical User Interface (GUI), and the like are used.

Japanese Laid-open Patent Publication No. 2006-268832 is disclosed as related art.

### SUMMARY

According to an aspect of the embodiments, a non-transitory computer-readable recording medium stores an execution control program for causing a computer to execute a process including: storing, for each of a plurality of commands common to a plurality of user interfaces, a function definition that defines processing to be executed in response to each of the plurality of commands with a combination of one or more classes among classes of a plurality of types; receiving an input of a specific command among the plurality of commands; and processing the specific command with the combination of the one or more classes defined by the function definition that corresponds to the received specific command.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an outline of an execution control method according to an embodiment;

FIG. 2 is a block diagram of an information processing device in which a machine learning (ML) framework according to the embodiment operates;

FIG. 3 is a diagram illustrating exemplary reference relationships between ML commands and ML base classes;

FIG. 4 is a diagram illustrating definition examples for individual user interfaces;

FIG. 5 is a diagram illustrating an exemplary ML framework for executing ‘train’;

FIG. 6 is a flowchart of an ML command execution process by an ML framework according to the embodiment; and

FIG. 7 is a hardware configuration diagram of the information processing device.

### DESCRIPTION OF EMBODIMENTS

Codes thereof are commonly independent of each other, and each user interface is created individually according to interface requirements at a time of use. Accordingly, each user interface has been individually developed and created in the past to create a plurality of different user interfaces.

Note that, as a technique related to machine learning, there has been proposed a technique in which multiple user interfaces for accessing a machine learning model are prepared and navigation may be performed while switching the user interfaces at a training stage.

However, when the user interfaces are individually developed and created, a large number of man-hours are needed to implement the multiple user interfaces even for the same machine learning model. Furthermore, when various user interfaces are individually created, the accuracy of the machine learning model may be unintentionally changed when a code is added at a time of interface creation.

The disclosed technique has been conceived in view of the above, and aims to provide an execution control program, an execution control method, and an information processing device that achieves easy and highly reliable user interface development.

Hereinafter, an embodiment of an execution control program, an execution control method, and an information processing device disclosed in the present application will be described in detail with reference to the drawings. Note that the execution control program, the execution control method, and the information processing device disclosed in the present application are not limited by the following embodiment.

### EMBODIMENT

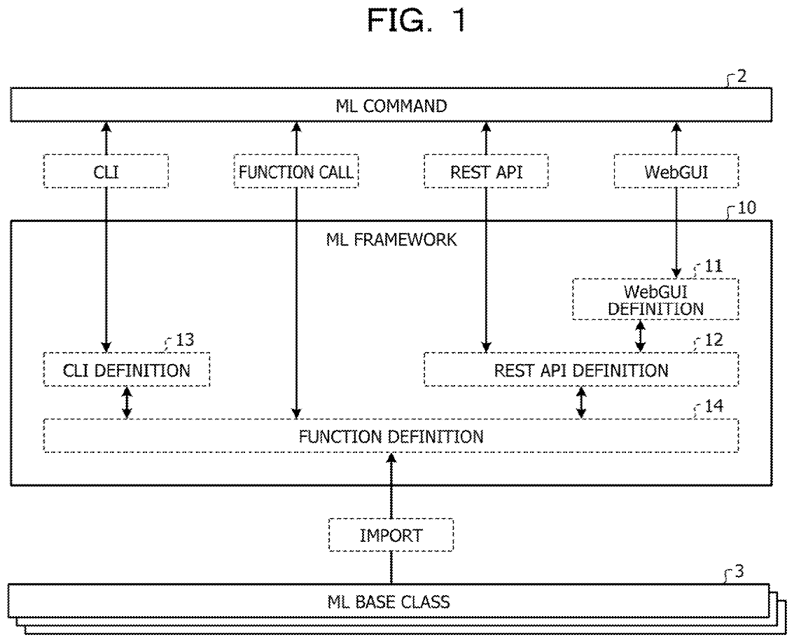

FIG. 1 is a diagram illustrating an outline of an execution control method according to an embodiment. An outline of a process when a machine learning (ML) command 2 related to machine learning is input will be described with reference to FIG. 1. An ML framework 10 illustrated in FIG. 1 is a framework that receives an input of the ML command 2, which is an instruction related to machine learning, from a user or an application that uses a machine learning model, and executes training processing of the machine learning model, inference processing using the machine learning model, and evaluation processing using an inference result. In the present embodiment, four user interfaces including a WebGUI, a REST API, a CLI, and a function call are used as user interfaces for developing or using the machine learning model.

The ML command 2 is a command for executing processing related to machine learning common to multiple user interfaces. For example, the ML command 2 includes data, sess, train, pred, eval, test, tune, sum, load, and the like.

The ‘data’ is a command that generates a data set for model training from raw data, and is used in all stages of training, inference, and evaluation. The ‘sess’ is a command that generates a session, which is a trial unit corresponding to one hyperparameter for model training. The ‘train’ is a command that executes training of the machine learning model using the data set generated by ‘data’ and the session generated by ‘sess’. The ‘pred’ is a command that executes inference using the machine learning model trained by “train”. The ‘load’ is a command that loads a trained machine learning model into a memory. Here, since the machine learning model tends to be large in size and greatly affects the processing speed when it is read every time it is used, the ML framework 10 commonly reads the machine learning model into the memory in advance using ‘load’. The ‘tune’ is a command that executes multiple types of training (‘train’) while automatically generating hyperparameters. The ‘eval’ is a command that compares data inferred by the trained machine learning model with ground truth data to output an evaluation result. The ‘test’ is a command that executes ‘pred’ and ‘eval’ in succession. The ‘sum’ is a command that summarizes the results of ‘eval’, for example, the evaluation results of the machine learning model, and outputs them as a list.

An ML base class 3 is created by a developer of an application using the machine learning model. The ML base class 3 is a class in which input and output are defined in advance. The ML base class 3 defines a process to be performed according to a command by one or more combinations for each command common to the four user interfaces to be used. For example, the developer designs and creates each ML base class 3 such that it may be used by each command common to the four user interfaces to be used. Then, the ML base class 3 is imported into the ML framework 10. As a result of this import, each function definition 14 is associated with one or more ML base classes 3 to be used in each function definition 14.

For example, in the present embodiment, DataGenerator, Trainer, Evaluator, Predictor, Model, Summarizer, Tuner, or the like is included in the ML base class 3 to be used in the ML command 2.

The ‘DataGenerator’ is a class for generating a data set for machine learning model training from raw data. The ‘Trainer’ is a class for executing model training. The ‘Evaluator’ is a class for comparing data inferred by the trained machine learning model with ground truth data and outputting an evaluation result. The ‘Predictor’ is a class for executing inference using the trained machine learning model. The ‘Model’ is a class for model architecture. However, this model architecture is a regression model, a Convolutional Neural Network (CNN) model, or the like, and does not include hyperparameters or trained parameters. The ‘Summarizer’ is a class for parsing the evaluation results of the machine learning model, which are the results of ‘eval’, and returning a summary. The ‘Tuner’ is a class for automatically generating a hyperparameter for training.

The ML framework 10 includes a WebGUI definition 11, a REST API definition 12, a CLI definition 13, and a function definition 14. The ML framework 10 uses the WebGUI definition 11, the REST API definition 12, the CLI definition 13, and the function definition 14 in a hierarchical design as illustrated in FIG. 1. For example, definitions corresponding to the individual ML commands 2 for the individual user interfaces are hierarchically arranged such that the function definition 14 is at the lowest in the hierarchy. Furthermore, although illustration is omitted, the ML framework 10 retains raw data to be used to generate training data and inference data, which are used for processing by the machine learning model.

The WebGUI definition 11 is information that defines processing to be performed when the ML command 2 is input through the WebGUI. Similarly, the REST API definition 12 is information that defines processing to be performed when the ML command 2 is input through the REST API. The CLI definition 13 is information that defines processing to be performed when the ML command 2 is input through the CLI. The function definition 14 is information that defines a function corresponding to the ML command 2 common to the four user interfaces. The function definition 14 defines a function that performs, using one or more ML base classes 3, processing to be performed according to each ML command 2 for each of a plurality of ML commands 2 common to a plurality of user interfaces.

In the case of the hierarchical design as illustrated in FIG. 1, it is sufficient if the WebGUI definition 11 at least includes an interface for calling the REST API. Furthermore, it is sufficient if the REST API definition 12 and the CLI definition 13 are defined at least as a wrapper code for the function definition 14, for example, processing for calling the function definition 14.

Next, processing of the ML command 2 performed by the ML framework 10 will be described. The ML framework 10 receives an input of the ML command 2 through one of the user interfaces WebGUI, REST API, CLI, and function call. The ML command 2 received by the ML framework 10 is an exemplary “specific command”.

When the input of the ML command 2 through the WebGUI is received, the ML framework 10 calls the REST API definition 12 that executes the ML command 2 of the REST API corresponding to the received ML command 2 according to the WebGUI definition 11. Next, the ML framework 10 calls the function definition 14 corresponding to the ML command 2 according to the called REST API definition 12. Next, the ML framework 10 performs processing using the ML base class 3 specified by the function definition 14 on various types of specified data according to the called function definition 14. Thereafter, the ML framework 10 responds to the input ML command 2 by, for example, returning the obtained processing result to the input source of the ML command 2.

The WebGUI is an exemplary first user interface, and the WebGUI definition 11 is an exemplary definition of the first user interface. Furthermore, the REST API is an exemplary second user interface, and the REST API definition 12 is an exemplary definition of the second user interface. For example, when the first user interface is used to input the specific command, the ML framework 10 calls the definition of the second user interface corresponding to the specific command using the definition of the first user interface corresponding to the specific command. Next, the ML framework 10 calls the function definition 14 corresponding to the specific command using the called definition of the second user interface, and processes the specific command using the called function definition 14 corresponding to the specific command.

When the input of the ML command 2 through the REST API is received, the ML framework 10 calls the function definition 14 corresponding to the input ML command 2 of the REST API according to the REST API definition 12. Next, the ML framework 10 performs processing using the ML base class 3 specified by the function definition 14 on various types of specified data according to the called function definition 14. Thereafter, the ML framework 10 responds to the input ML command 2 by, for example, returning the obtained processing result to the input source of the ML command 2.

For example, when the second user interface is used to input the specific command, the ML framework 10 calls the function definition 14 corresponding to the specific command using the definition of the second user interface corresponding to the specific command, and processes the specific command using the called function definition 14 corresponding to the specific command.

When the input of the ML command 2 through the CLI is received, the ML framework 10 calls the function definition 14 corresponding to the input ML command 2 of the CLI according to the CLI definition 13. Next, the ML framework 10 performs processing using the ML base class 3 specified by the function definition 14 on various types of specified data according to the called function definition 14. Thereafter, the ML framework 10 responds to the input ML command 2 by, for example, returning the obtained processing result to the input source of the ML command 2.

When the input of the ML command 2 through the function call is received, the ML framework 10 performs processing using the ML base class 3 specified by the function definition 14 on various types of specified data according to the function definition 14 specified by the function call. Thereafter, the ML framework 10 responds to the input ML command 2 by, for example, returning the obtained processing result to the input source of the ML command 2.

In this manner, the ML framework 10 repeatedly calls the user interface corresponding to the specific command one level lower in the hierarchy in the order from the definition of the user interface used to input the specific command until the function definition 14 corresponding to the specific command is called, and processes the specific command using the called function definition 14.

For example, the ML framework 10 according to the present embodiment only needs to define a minimum definition for calling the next hierarchy as the WebGUI definition 11, the REST API definition 12, and the CLI definition 13. Accordingly, the developer only needs to design and develop the ML base class 3 to correspond to the ML command 2 common to each interface, and basically does not need to develop the four interfaces independently.

However, the ML framework 10 may provide the developer with a function of customizing the definition of each user interface by overwriting, adding, or the like depending on individual requirements.

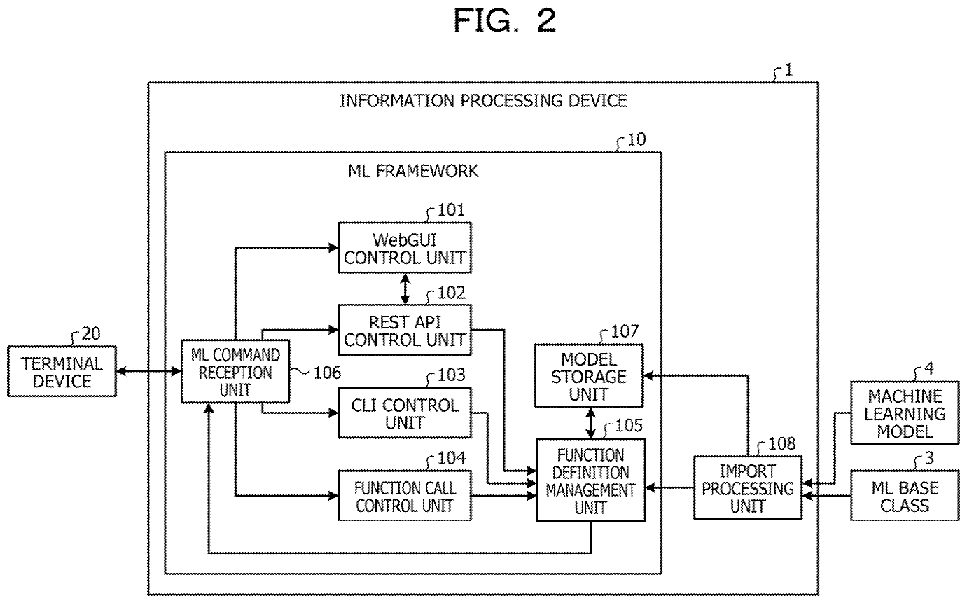

FIG. 2 is a block diagram of an information processing device in which the ML framework according to the embodiment operates. Next, an information processing device 1 will be described for each function with reference to FIG. 2. As illustrated in FIG. 2, the information processing device 1 includes a WebGUI control unit 101, a REST API control unit 102, a CLI control unit 103, a function call control unit 104, a function definition management unit 105, an ML command reception unit 106, a model storage unit 107, and an import processing unit 108. The WebGUI control unit 101, the REST API control unit 102, the CLI control unit 103, the function call control unit 104, the function definition management unit 105, and the ML command reception unit 106 are implemented by the ML framework 10.

The import processing unit 108 receives inputs of the ML base class 3 and a machine learning model 4. Then, the import processing unit 108 imports the ML base class 3, and causes the function definition management unit 105 to store a reference relationship of the ML base class 3 to be used to execute each ML command 2. The import processing unit 108 may be arranged in an external device of the information processing device 1.

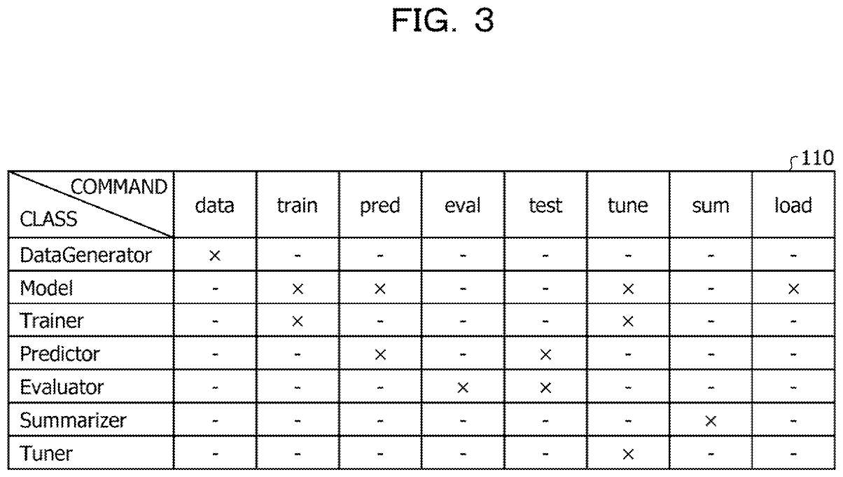

FIG. 3 is a diagram illustrating exemplary reference relationships between the ML commands and the ML base classes. In a table 110 illustrated in FIG. 3, horizontally aligned items represent types of the ML command 2, and vertically aligned items represent types of the ML base class 3.

For example, ‘data’ in the ML command 2 refers to ‘DataGenerator’ in the ML base class 3. Furthermore, ‘train’ in the ML command 2 refers to ‘Model’ and ‘Trainer’ in the ML base class 3. Furthermore, ‘pred’ in the ML command 2 refers to ‘Model’ and ‘Predictor’ in the ML base class 3. Furthermore, ‘eval’ in the ML command 2 refers to ‘Evaluator’ in the ML base class 3. Furthermore, ‘test’ in the ML command 2 refers to ‘Predictor’ and ‘Evaluator’ in the ML base class 3. Furthermore, ‘tune’ in the ML command 2 refers to ‘Model’, ‘Trainer’, and ‘Tuner’ in the ML base class 3. Furthermore, ‘sum’ in the ML command 2 refers to ‘Summarizer’ in the ML base class 3. Furthermore, ‘load’ in the ML command 2 refers to ‘Model’ in the ML base class 3.

Furthermore, the import processing unit 108 receives an input of the machine learning model 4. Then, the import processing unit 108 causes the model storage unit 107 to store the machine learning model 4.

The model storage unit 107 receives the input of the machine learning model 4 from the import processing unit 108. Then, the model storage unit 107 stores the machine learning model 4. Thereafter, the model storage unit 107 passes the machine learning model 4 to the function definition management unit 105 according to an instruction from the function definition management unit 105. When the function definition management unit 105 updates a hyperparameter, the model storage unit 107 newly retains the updated machine learning model 4. After the training is complete, the model storage unit 107 retains the trained machine learning model 4.

The ML command reception unit 106 receives the ML command 2 input from an external terminal device 20. Then, the ML command reception unit 106 determines which one of the WebGUI, REST API, CLI, and function call is used to input the ML command 2.

When the ML command 2 is input through the WebGUI, the ML command reception unit 106 outputs the received ML command 2 to the WebGUI control unit 101. Furthermore, when the ML command 2 is input through the REST API, the ML command reception unit 106 outputs the received ML command 2 to the REST API control unit 102. Furthermore, when the ML command 2 is input through the CLI, the ML command reception unit 106 outputs the received ML command 2 to the CLI control unit 103. Furthermore, when the ML command 2 is input through the function call, the ML command reception unit 106 outputs the received ML command 2 to the function call control unit 104.

Thereafter, the ML command reception unit 106 receives a processing result for the received ML command 2 from the function definition management unit 105. Then, the ML command reception unit 106 transmits the processing result to the terminal device 20 as a response to the ML command 2.

The WebGUI control unit 101 has the WebGUI definition 11 for each ML command 2. The WebGUI control unit 101 receives the input of the ML command 2 input through the WebGUI from the ML command reception unit 106. Then, the WebGUI control unit 101 identifies the REST API definition 12 corresponding to the obtained ML command 2 according to the WebGUI definition 11 of the obtained ML command 2. Next, the WebGUI control unit 101 instructs the REST API control unit 102 to execute the identified ML command 2.

The REST API control unit 102 has the REST API definition 12 for each ML command 2. The REST API control unit 102 receives the input of the ML command 2 input through the REST API from the ML command reception unit 106. Then, the REST API control unit 102 identifies the function definition 14 corresponding to the obtained ML command 2 according to the REST API definition 12 of the obtained ML command 2. Next, the REST API control unit 102 instructs the function definition management unit 105 to execute the identified function definition 14 corresponding to the ML command 2.

Furthermore, the REST API control unit 102 receives the instruction to execute the ML command 2 from the WebGUI control unit 101. Then, the REST API control unit 102 identifies the function definition 14 corresponding to the obtained ML command 2 according to the REST API definition 12 of the specified ML command 2. Next, the REST API control unit 102 instructs the function definition management unit 105 to execute the identified function definition 14 corresponding to the ML command 2.

The CLI control unit 103 has the CLI definition 13 for each ML command 2. The CLI control unit 103 receives the input of the ML command 2 input through the CLI from the ML command reception unit 106. Then, the CLI control unit 103 identifies the function definition 14 corresponding to the obtained ML command 2 according to the CLI definition 13 of the obtained ML command 2. Next, the CLI control unit 103 instructs the function definition management unit 105 to execute the identified function definition 14 corresponding to the ML command 2.

The function call control unit 104 receives the input of the ML command 2 input through the function call from the ML command reception unit 106. Then, the function call control unit 104 instructs the function definition management unit 105 to execute the function definition 14 corresponding to the ML command 2 of the function call.

The function definition management unit 105 receives the import of the ML base class 3 from the import processing unit 108. Then, the function definition management unit 105 stores the ML command 2 common to a plurality of user interfaces and the ML base class 3 referenced by each ML command 2 in association with each other.

The function definition management unit 105 receives the instruction to execute the function definition 14 corresponding to the input ML command 2 from the REST API control unit 102, the CLI control unit 103, or the function call control unit 104. Then, the function definition management unit 105 executes the function definition 14 corresponding to the ML command 2, which has been instructed. For example, the function definition management unit 105 executes the ML base class 3 included in the specified function definition 14 according to the definition. At this time, according to the ML base class 3 to be executed, the function definition management unit 105 obtains the machine learning model 4 from the model storage unit 107 to execute processing, or execute the processing using raw data. Thereafter, the function definition management unit 105 outputs a processing result to the ML command reception unit 106. Furthermore, when the machine learning model 4 is updated, the function definition management unit 105 outputs the updated machine learning model 4 to the model storage unit 107 to store it.

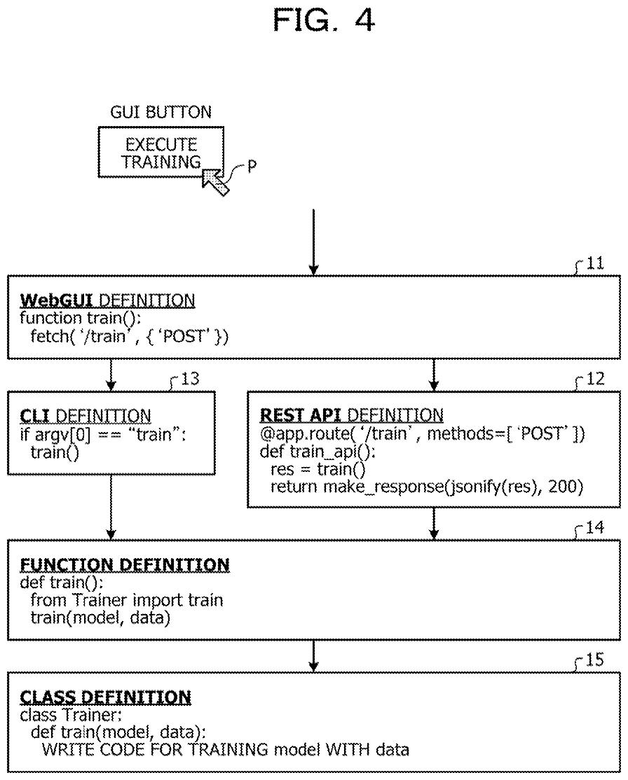

FIG. 4 is a diagram illustrating definition examples for individual user interfaces. Here, a case where ‘train’ is input as the ML command 2 will be described.

When an operator presses, using a mouse or the like, a training execution GUI button on the external terminal device 20 as indicated by an arrow P, the terminal device 20 inputs ‘train’ to the ML framework 10.

The ML framework 10 calls the definition of ‘train’ of each user interface depending on the user interface through which the input has been made.

For example, when the ML command 2 is input through the WebGUI, the WebGUI definition 11 of ‘train’ is called. Then, the WebGUI definition 11 of ‘train’ calls a POST method of the REST API definition 12, and designates ‘train’ as a resource. The REST API definition 12 calls the function definition 14 of ‘train’ in response to the call of the POST method using ‘train’ as a resource. The called function definition 14 of ‘train’ trains a model with data using the ML base class 3 of ‘Trainer’ defined in a class definition 15. In the class definition 15 of the ML base class 3 of ‘Trainer’, a code for training the machine learning model 4 designated as the model with training data designated as the data is written. As a result, the ML framework 10 is enabled to train the machine learning model 4 using the designated training data.

Furthermore, when the ML command 2 is input through the REST API, the REST API definition 12 of ‘train’ is directly called. The REST API definition 12 of ‘train’ calls the function definition 14 of ‘train’. The called function definition 14 of ‘train’ trains a model with data using the ML base class 3 of ‘Trainer’ defined in a class definition 15. As a result, the ML framework 10 is enabled to train the machine learning model 4 using the designated training data.

Furthermore, when the ML command 2 is input through the CLI, the CLI definition 13 of ‘train’ is directly called. The CLI definition 13 of ‘train’ calls the function definition 14 of ‘train’. The called function definition 14 of ‘train’ trains a model with data using the ML base class 3 of ‘Trainer’ defined in a class definition 15. As a result, the ML framework 10 is enabled to train the machine learning model 4 using the designated training data.

Furthermore, when the ML command 2 is input through the function call, the function definition 14 of ‘train’ is directly called. The called function definition 14 of ‘train’ trains a model with data using the ML base class 3 of ‘Trainer’ defined in a class definition 15. As a result, the ML framework 10 is enabled to train the machine learning model 4 using the designated training data.

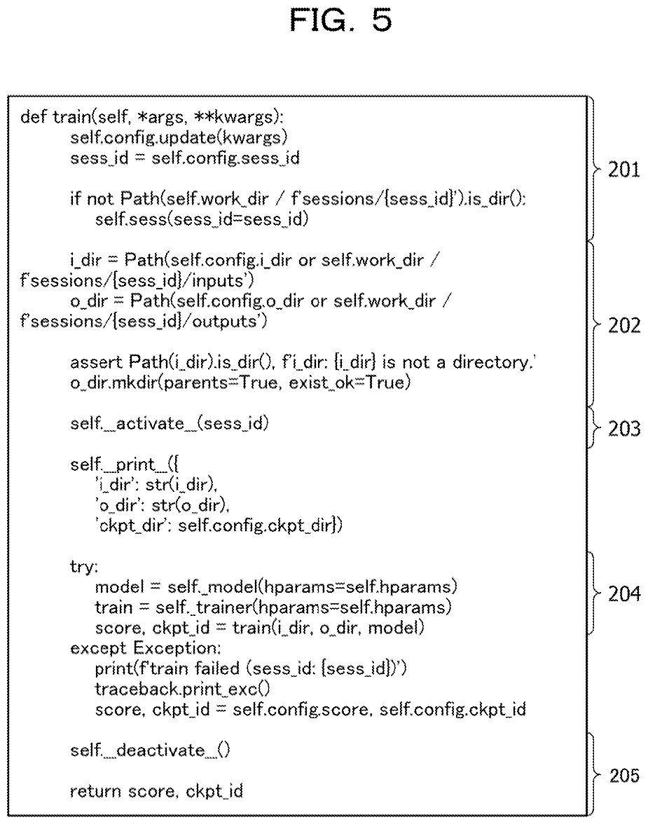

FIG. 5 is a diagram illustrating an exemplary ML framework for executing ‘train’. Next, an example of the ML framework 10 for executing ‘train’ will be described with reference to FIG. 5.

The ML framework 10 illustrated in FIG. 5 obtains a session based on syntax in a range 201. Next, the ML framework 10 sets an input/output folder for training execution based on syntax in a range 202. Next, the ML framework 10 specifies the session based on syntax in a range 203. As a result, the ML framework 10 uniquely specifies a hyperparameter and a code to be used for this training from among multiple hyperparameters and codes. Next, the ML framework 10 generates the machine learning model 4 based on the specified hyperparameter according to syntax in a range 204. Then, the ML framework 10 carries out training using the generated machine learning model 4. Thereafter, the ML framework 10 releases the session and returns, to the input source of the ML command 2, a score value of the machine learning model 4 obtained as an optimum result and ID of the score value based on syntax in a range 205.

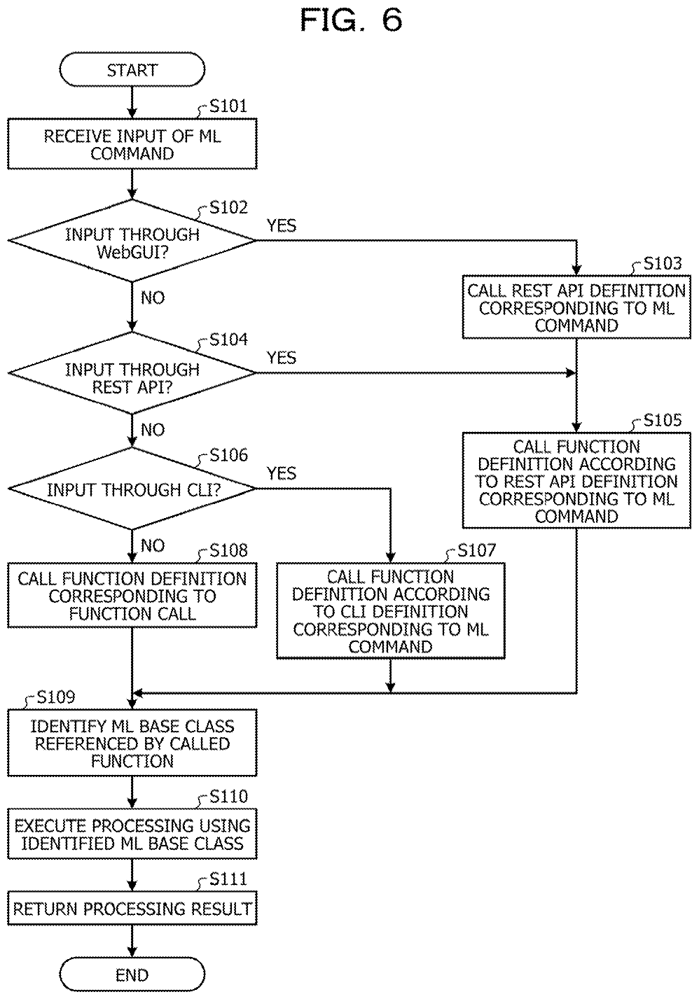

FIG. 6 is a flowchart of an ML command execution process by the ML framework according to the embodiment. Next, a flow of the execution process of the ML command 2 by the ML framework 10 according to the present embodiment will be described with reference to FIG. 6.

The ML command reception unit 106 receives an input of the ML command 2 from the terminal device 20 (step S101).

Next, the ML command reception unit 106 determines whether or not the input of the ML command 2 is made through the WebGUI (step S102).

If it is input through the WebGUI (Yes in step S102), the ML command reception unit 106 outputs the ML command 2 to the WebGUI control unit 101. The WebGUI control unit 101 calls the REST API definition 12 corresponding to the ML command 2 according to the WebGUI definition 11 of the input ML command 2 (step S103). Thereafter, the execution process of the ML command 2 proceeds to step S105.

On the other hand, if it is not input through the WebGUI (No in step S102), the ML command reception unit 106 determines whether or not the input of the ML command 2 is made through the REST API (step S104).

If it is input through the REST API (Yes in step S104), the ML command reception unit 106 outputs the ML command 2 to the REST API control unit 102, and calls the REST API definition 12 corresponding to the ML command 2. Then, the execution process of the ML command 2 proceeds to step S105.

When the REST API definition 12 corresponding to the ML command 2 is called, the REST API control unit 102 calls the function definition 14 corresponding to the ML command 2 according to the called REST API definition 12 (step S105). Thereafter, the execution process of the ML command 2 proceeds to step S109.

On the other hand, if it is not input through the REST API (No in step S104), the ML command reception unit 106 determines whether or not the input of the ML command 2 is made through the CLI (step S106).

If it is input through the CLI (Yes in step S106), the ML command reception unit 106 outputs the ML command 2 to the CLI control unit 103, and calls the CLI definition 13 corresponding to the ML command 2. When the CLI definition 13 corresponding to the ML command 2 is called, the CLI control unit 103 calls the function definition 14 corresponding to the ML command 2 according to the called CLI definition 13 (step S107). Thereafter, the execution process of the ML command 2 proceeds to step S109.

On the other hand, if it is not input through the CLI (No in step S106), the ML command reception unit 106 outputs the received function call to the function call control unit 104. The function call control unit 104 calls the function definition 14 corresponding to the input function call (step S108). Thereafter, the execution process of the ML command 2 proceeds to step S109.

When the function definition 14 is called, the function definition management unit 105 identifies the ML base class 3 referenced by the called function definition 14 (step S109).

Thereafter, the function definition management unit 105 executes, using the identified ML base class 3, the processing specified by the function definition management unit 105 corresponding to the ML command 2 (step S110).

Thereafter, when the processing specified by the ML command 2 is complete, the function definition management unit 105 transmits a processing result to the terminal device 20 to respond with the processing result (step S111).

As described above, the ML framework that operates in the information processing device according to the present embodiment uses the ML command common to the plurality of user interfaces. Then, the ML framework retains the plurality of ML base classes designed and developed to be used in the common ML command. Then, the ML framework retains the definitions of the user interfaces in a hierarchical manner, and upon reception of the input of the common ML command, the ML framework repeats the process of calling the user interface lower in the hierarchy using the definition corresponding to the user interface through which the ML command is input. Finally, it calls the function definition at the lowest in the hierarchy, and executes the processing using the ML base class referenced by the called function definition to return a response.

In this manner, it is sufficient if the information processing device according to the present embodiment simply calls the definition of the user interface lower in the hierarchy among the hierarchical definitions of the individual user interfaces. By repeating such a simple virtual user interface call, the information processing device is enabled to finally execute the processing using the same function definition regardless of which user interface is used to input the ML command. Thus, it becomes possible to avoid implementing individual user interfaces each time in a case of being applied to various machine learning tasks. Furthermore, development of individual user interfaces is omitted, whereby an unintentional change in the accuracy of the machine learning model may be avoided. Therefore, it becomes possible to achieve easy and highly reliable user interface development.

(Hardware Configuration)

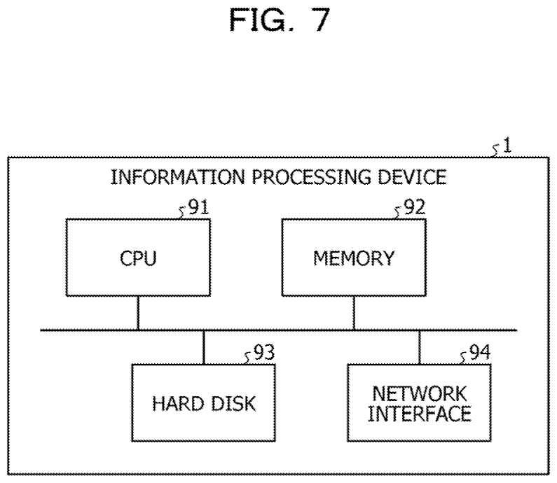

FIG. 7 is a hardware configuration diagram of the information processing device. Next, an exemplary hardware configuration for implementing each function of the information processing device 1 will be described with reference to FIG. 7.

As illustrated in FIG. 7, the information processing device 1 includes, for example, a central processing unit (CPU) 91, a memory 92, a hard disk 93, and a network interface 94. The CPU 91 is coupled to the memory 92, the hard disk 93, and the network interface 94 via a bus.

The network interface 94 is an interface for communication between the information processing device 1 and an external device. The network interface 94 relays communication between, for example, the terminal device 20 and the CPU 91.

The hard disk 93 is an auxiliary storage device. The hard disk 93 implements the function of the model storage unit 107 exemplified in FIG. 2. Furthermore, the hard disk 93 stores various programs including programs to be described below. For example, the hard disk 93 stores programs for implementing the functions of the WebGUI control unit 101, the REST API control unit 102, the CLI control unit 103, the function call control unit 104, and the function definition management unit 105 exemplified in FIG. 2. Furthermore, the hard disk 93 stores programs for implementing the functions of the ML command reception unit 106 and the import processing unit 108 exemplified in FIG. 2.

The memory 92 is a main storage device. For example, a dynamic random access memory (DRAM) may be used as the memory 92.

The CPU 91 reads various programs from the hard disk 93, and loads them in the memory 92 for execution. As a result, the CPU 91 implements the functions of the WebGUI control unit 101, the REST API control unit 102, the CLI control unit 103, the function call control unit 104, the function definition management unit 105, the ML command reception unit 106, and the import processing unit 108 exemplified in FIG. 2.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an execution control program for causing a computer to execute a process comprising:
storing, for each of a plurality of commands common to a plurality of user interfaces, a function definition that defines processing to be executed in response to each of the plurality of commands with a combination of one or more classes among classes of a plurality of types;
receiving an input of a specific command among the plurality of commands; and
processing the specific command with the combination of the one or more classes defined by the function definition that corresponds to the received specific command.

2. The non-transitory computer-readable recording medium according to claim 1, the recording medium storing the execution control program for causing the computer to execute the process further comprising:
hierarchically arranging a definition that corresponds to each of the commands for each of the user interfaces such that the function definition is at a lowest layer; and
repeating calling of the definition of the user interface that corresponds to the specific command at a one level lower layer in order from the definition of the user interface used to input the specific command until the function definition that corresponds to the specific command is called, and processing the specific command using the called function definition.

3. The non-transitory computer-readable recording medium according to claim 1, the recording medium storing the execution control program for causing the computer to execute the process further comprising:
storing, for each of the commands, a definition of a first user interface, a definition of a second user interface, and the function definition;
when the first user interface is used to input the specific command, calling the definition of the second user interface that corresponds to the specific command using the definition of the first user interface that corresponds to the specific command, calling the function definition that corresponds to the specific command using the called definition of the second user interface, and processing the specific command using the called function definition that corresponds to the specific command; and
when the second user interface is used to input the specific command, calling the function definition that corresponds to the specific command using the definition of the second user interface that corresponds to the specific command, and processing the specific command using the called function definition that corresponds to the specific command.

4. The non-transitory computer-readable recording medium according to claim 1, wherein the plurality of commands is an instruction that causes processing related to a machine learning model to be executed.

5. An execution control method comprising:
storing, for each of a plurality of commands common to a plurality of user interfaces, a function definition that defines processing to be executed in response to each of the plurality of commands with a combination of one or more classes among classes of a plurality of types;
receiving an input of a specific command among the plurality of commands; and
processing the specific command with the combination of the one or more classes defined by the function definition that corresponds to the received specific command.

6. An information processing device comprising:
a memory; and
a processor coupled to the memory and configured to:
store, for each of a plurality of commands common to a plurality of user interfaces, a function definition that defines processing to be executed in response to each of the plurality of commands with a combination of one or more classes among classes of a plurality of types;
receive an input of a specific command among the plurality of commands; and
process the specific command with the combination of the one or more classes defined by the function definition that corresponds to the received specific command.
